(19) United States
(12) Patent Application Publication
(10) Pub. No.: US 2014/0164540 A1
(43) Pub. Date: Jun. 12, 2014

(54) METHOD OF WRITING MESSAGE AND ELECTRONIC DEVICE FOR PROCESSING THE SAME

(71) Applicant: Samsung Electronics Co., Ltd, Gyeonggi-do (KR)

(72) Inventor: Jin Park, Gyeonggi-do (KR)

(73) Assignee: Samsung Electronics Co., Ltd, Gyeonggi-do (KR)

(21) Appl. No.: 14/102,308

(22) Filed: Dec. 10, 2013

(30) Foreign Application Priority Data
Dec. 10, 2012 (KR) 10-2012-0142827

(51) Int. Cl. H04L 12/58

(52) U.S. Cl. CPC H04L 51/04
USPC 709/206

(57) ABSTRACT

A device performs a method for writing a message by an electronic device. The method for writing the message in the electronic device includes collecting information with which a recent situation of a conversation partner may be recognized, writing a greeting message before writing a main message by using the collected information with which the recent situation of the conversation partner may be recognized, and transmitting the greeting message to the conversation partner.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Dec. 10, 2012 and assigned Serial No. 10-2012-0142827, the contents of which are incorporated herein by reference.

### TECHNICAL FIELD OF THE INVENTION

The present disclosure relates generally to a device and method for processing a message in an electronic device.

### BACKGROUND OF THE INVENTION

Due to the recent rapid development of electronic devices, electronic devices enabling wireless voice calls and information exchanges have become daily necessities. The electronic devices have been recognized as being able to be portable and make wireless calls at the early stage of propagation, but as the technology develops and wireless internet is introduced, the electronic device is used for the purpose of simple phone calls or schedule management and the applicable range of the electronic device widens to a remote control using near field communication and to capturing an image by using an equipped digital camera to satisfy user demands.

As electronic devices provide a multimedia service as described above, an amount of information to be processed and an amount of information to be displayed are increasing. Thus, an interest in an electronic device that has a touch screen is increasing, the touch screen being capable of increasing the size of a display unit by improving spatial utilization.

The touch screen is an input and display device that enables inputting and displaying information to be performed on one screen. Thus, when the touch screen is used, the electronic device may remove a need for a separate input device such as a keypad and thus increase a display area. For example, when a full touch scheme in which the touch screen is applied to the entire screen is used, it is possible to expand the size of a screen by utilizing the front surface of the electronic device as the screen.

In addition, the electronic device uses an instant messenger, a text message, an email, etc. to provide a function of transmitting a message to a specific conversation partner.

In general, the electronic device stores a list of conversation partners, and transmits and receives a message to and from a conversation partner selected by a user from the list of conversation partners.

The messages that are transmitted and received to and from the conversation partner are stored in the electronic device, and the content of the transmitted and received messages is displayed on the conversation screen of the conversation partner.

However, since transmitting and receiving the messages indicates that conversation is performed by using writing among users, transmitting a message to a conversation partner who is not close may be awkward.

Since a message that simply includes greetings may be transmitted to the conversation partner but in most cases formal greetings are transmitted, an awkward atmosphere may be maintained among users who transmit and receive the message.

### SUMMARY OF THE INVENTION

To address the above-discussed deficiencies of the prior art, it is a primary object to provide a device and method for recognizing a recent situation of a conversation partner before writing or receiving a message by an electronic device.

Another object of the present disclosure is to provide a device and method for sharing information on the recent situation with a conversation partner by the electronic device.

Another object of the present disclosure is to provide a device and method for starting a conversation by using information on the recent situation by the electronic device.

Another object of the present disclosure is to provide a device and method for displaying, on a conversation screen, information on the recent situation of a conversation partner by the electronic device.

Another object of the present disclosure is to provide a device and method for creating a topic for starting a conversation by using the profile of a conversation counterpart by the electronic device.

According to an aspect of the present disclosure, a method of writing a message by means of an electronic device including collecting information through which a recent situation of a conversation partner is recognized, and transmitting a greeting message to the conversation partner, wherein the greeting message is written before writing a message by using the collected conversation information.

The method may further include sharing the collected conversation information with the conversation partner.

The collecting of the conversation infolination may be performed when a conversation partner receiving a written message is designated or when a message is received from a conversation partner.

The collecting of the conversation information may include one of collecting information registered with a network by the conversation partner and collecting communication records between a user of the electronic device and the conversation partner.

The collecting of the conversation information may include generating conversation information by using a profile of a conversation partner selected to receive a message.

The collected conversation information may be displayed on a message writing screen or set as the background of the message writing screen.

The message may include one of a text message, an instant message, an email, and a multimedia message.

The collecting of the conversation information may include collecting at least one of pictures, writings, and personal events that are registered with a network by a conversation partner, content of messages that have been transmitted to and received from a conversation partner, and data transmitted to and received from a conversation partner.

According to another aspect of the present disclosure, a device for writing a message by means of an electronic device includes at least one processor and a memory. The at least one processor is configured to collect information through which a recent situation of a conversation partner is recognized, and to write and transmit a greeting message to the conversation partner, wherein the greeting message is written before writing a message by using the collected conversation information.

The at least one processor may be configured to share the collected conversation information with the conversation partner.

The at least one processor may be configured to collect the conversation information, when a conversation partner receiving a written message is designated or when a message is received from a conversation partner.

The at least one processor may be configured to collect the conversation information, with information registered with a network by the conversation partner and communication records between a user of the electronic user and the conversation partner.

The at least one processor may be configured to generate the conversation information by using a profile of a conversation partner selected to receive a message.

The at least one processor may be configured to display the conversation information on a message writing screen or to set the conversation information as the background of the message writing screen.

The at least one processor may be configured to collect the conversation information, when a message is written by using one of a text message, an instant message, an email, and a multimedia message.

The at least one processor may be configured to collect, as the conversation information, at least one of pictures, writings, and personal events that are registered with a network by a conversation partner, content of messages that have been transmitted to and received from a conversation partner, and data transmitted to and received from a conversation partner.

According to another aspect of the present disclosure, a non-transitory computer readable recording medium encoded with at least one program that includes instructions that when executed by an electronic device, cause the electronic device to perform collecting information through which a recent situation of a conversation partner is recognized; and transmitting a greeting message to the conversation partner, wherein the greeting message is written before writing a message by using the collected conversation information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a configuration of an electronic device that provides a function of writing a message according to the present disclosure;

FIG. 2 is a flow chart of a message writing process by an electronic device according to an embodiment of the present disclosure;

FIG. 3 is a flow chart of a message writing process by an electronic device according to another embodiment of the present disclosure;

FIG. 4 is a flow chart of a message receiving process by an electronic device according to an embodiment of the present disclosure;

FIG. 5 is a flow chart of a message receiving process by an electronic device according to another embodiment of the present disclosure;

FIG. 6 is a flow chart of an activity information collecting process by an electronic device according to an embodiment of the present disclosure;

FIGS. 7A to 7D show message writing screens of an electronic device according to an embodiment of the present disclosure;

FIGS. 8A and 8B show message receiving screens of an electronic device according to an embodiment of the present disclosure;

FIGS. 9A to 9C show message receiving screens of an electronic device according to another embodiment of the present disclosure;

FIGS. 10A to 10D show message writing screens of an electronic device according to another embodiment of the present disclosure; and

FIGS. 11A and 11B show message writing screens of an electronic device according to another embodiment of the present disclosure.

### DETAILED DESCRIPTION OF THE INVENTION

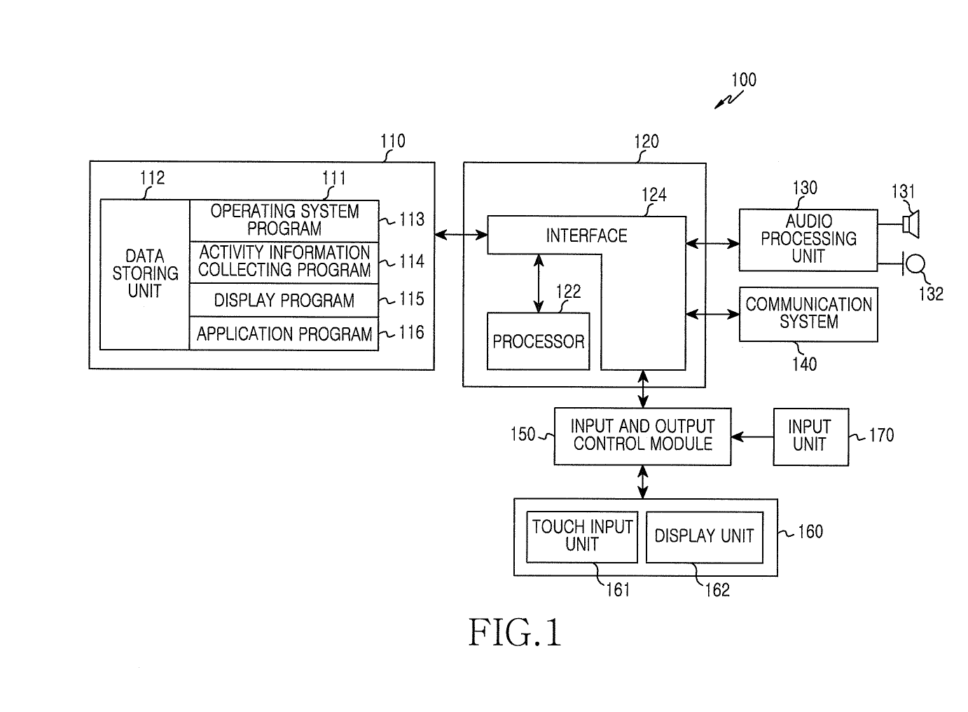

FIGS. 1 through 11B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Exemplary embodiments of the present disclosure will be described below in more detail with reference to the accompanying drawings. Moreover, detailed descriptions related to well-known functions or configurations will be omitted in order not to unnecessarily obscure the subject matter of the present disclosure. The terms described below are those defined by considering the functions in embodiments of the present disclosure and may vary depending on the intention of a user or an operator or practice. Therefore, the definitions will be made on the basis of the contents throughout the specification.

In the following description, a device and method for enabling a natural conversation among users will be described, which conversation is performed by recognizing the recent activity information of a conversation partner and displaying it on a part of a screen when an electronic device according to the present disclosure writes or receives a message. Here, the message is a message transmitted to a counterpart and means the content of an instant messenger, a text message, or an email. The activity information is the activity of a conversation partner recorded on a network and may include pictures, writing, and personal events that are registered by the conversation partner.

For example, the activity information may be pictures, writings (for example, a restaurant review, a product review, a travel review, and personal feelings), a user birthday, and family-member birthdays that are registered with a social network by a conversation partner designated by a user of the electronic device.

The activity information may be communication records (e.g., transmitting and receiving data, messages, and emails) between a user of the electronic device and the user's conversation partner.

In some embodiments, the activity information may be the content of messages that are transmitted and received to and from the conversation partner formerly through an email, a text message, or a messenger.

Such activity information may be transmitted to the conversation partner by means of the electronic device and thus users who desire to start a conversation may sustain a conversation based on at least shared activity information before a major conversation.

Moreover, the electronic device displays at least one of a number of pieces of activity information on a conversation partner and may share the activity information selected by a user with the conversation partner while displaying pieces of activity information.

Moreover, the activity information in the present disclosure means a common topic that may alleviate awkwardness and lead to a natural conversation, and representative information indicates at least one of a number of pieces of activity information that is selected among the pieces of activity information to be used as a common topic. Such information may be the recent situation information of a conversation partner.

Moreover, the electronic device may be a portable electronic device, and may include devices such as portable terminals, mobile phones, media players, tablet computers, handheld computers, or personal digital assistants (PDAs). Moreover, the electronic device may also be any portable electronic device that includes a device having a combination of two or more functions of such devices.

FIG. 1 is a block diagram of a configuration of an electronic device that provides a message writing function according to the present disclosure.

As shown in FIG. 1, the electronic device 100 includes a memory 110, a processor unit 120, an audio processing unit 130, a communication system 140, an input and output control unit 150, a touch screen 160, and an input unit 170. Here, each of the memory 110 and the communication system 140 may be present in plural.

The memory 110 includes a program storing unit 111 that stores programs for controlling the operation of the electronic device 100, and a data storing unit 112 that stores data generated while executing the programs. For example, the data storing unit 112 stores various types of updatable data such as telephone numbers, transmitted messages, and received messages, and in particular stores activity information on a conversation partner according to the present disclosure. Here, the activity information indicates a topic that enables a short conversation (for example, greetings) before a major conversation with a conversation partner, and may be data and messages that are transmitted and received to and from the conversation partner by a user of the electronic device. In addition, the activity information may be collected from a server on which the activities of the conversation partner are recorded, and the activity information collected from the server may be stored in the data storing unit 112.

Moreover, the program storing unit 111 includes an operating system program 113, an activity information collecting program 114, a display program 115, and at least one application program 116. Here, the programs included in the program storing unit 111 may be represented as a set of instructions.

The operating system program 113 includes several software components that control a general system operation. The control of such a general system operation means, for example, memory management and control, storage hardware (device) control and management, and power control and management. Such an operating system program 113 also performs a function of making communication between multiple hardware (devices) and program components (modules) smooth.

The activity information collecting program 114 may include several software components for collecting activity information that is a topic (information) that may be used for a short conversation (for example, greetings) before a major conversation with a conversation partner.

That is, the activity information collecting program 114 may recognize a conversation partner that is designated by user input, and perform processing to collect the activity information on the recognized conversation partner from the data storing unit 112 or a server that provides a service that the conversation partner uses.

As an example, if a user of the electronic device designates “Andrew” as a conversation partner, the activity information collecting program 114 may access a first server (a social service server that provides an A service), collect the records of the conversation partner “Andrew” (writing and pictures that are registered by the conversation partner), access a second server (a social service server that provides a B service), and collect the records of the conversation partner “Andrew”. In this way, the activity information collecting program 114 accesses a plurality of external servers from which activity information may be collected, and collects the records of the conversation partner “Andrew”.

In certain embodiments, the activity information collecting program 114 may collect the activity information on the conversation partner by using a function (open API) opened by a service that the conversation partner uses. For example, after the activity information collecting program 114 performs a function of requesting activity information by using a server URL and the information on the conversation partner (e.g., the ID and name of the conversation partner), it may receive the activity information corresponding to the conversation partner from a corresponding server.

As previously described, when a conversation partner is designated, the activity information collecting program 114 may access an external server and collect the activity information corresponding to the conversation partner; but in other scenarios, after periodically collecting and storing, from an external server, activity information on each user included in a list of conversation partners, the activity information collecting program 114 may collect the activity information corresponding to a conversation partner among pre-stored information when the conversation partner is designated.

As another example, if a user of the electronic device designates “Andrew” as a conversation partner, the activity information collecting program 114 may collect activity information that corresponds to the conversation partner “Andrew” among records stored in the data storing unit 112. Here, the records stored in the data storing unit 112 are records on messages and data that is transmitted and received to and from another user by the user of the electronic device, and the activity information collecting program 114 may collect records related to the conversation partner “Andrew” through classification.

In addition, the activity information collecting program 114 may transmit the collected activity information to the conversation partner and perform processing so that the activity information may be shared.

The display program 115 may include several software components for providing and displaying graphics on the touch screen 160. The graphics may include texts, web pages, icons, digital images, videos, animation, and the like.

In addition, the display program 115 may include several software components for displaying the activity information related to the conversation partner. That is, the display program 115 may display the activity information related to the conversation partner simultaneously with displaying the conversation screen of the designated conversation partner (a screen that includes an area in which the content of previous conversations and messages may be input) when the conversation partner is designated, the time being designated by the user of the electronic device.

In addition, if the display program 115 receives a message, it may display the content of the received message and simultaneously display the activity information related to the conversation partner that has transmitted the message. In certain embodiments, the display program 115 may display activity information whenever receiving a message; but since the activity information is information used for a short conversation (greetings) before a major conversation, the display program 115 may check conversation records with a conversation partner when receiving a message and then display the activity information if there is a certain time interval between the transmission and reception time of a previous message and the reception time of a new message.

As an example, the display program may display activity information based on a date. If a message is transmitted or received to or from a conversation partner for the first time everyday, the activity information on the conversation partner may be displayed.

The application program 116 includes software components for at least one application program that is installed in the electronic device 100. In the present disclosure, an instant messenger, and a text message and email function may also be a type of application program 116.

The processor unit 120 includes at least a processor 122 and an interface 124. Here, the processor 122 and the interface 124 may be faulted as at least one integrated circuit or implemented as a separate component.

The interface 124 functions as a memory interface that controls an access of the processor 122 to the memory 110. In addition, the interface 124 functions as a peripheral device interface that controls a connection of the processor 122 to the input and output peripheral devices of the electronic device 100.

The processor 122 controls at least one software program so that the electronic device 100 according to the present disclosure displays activity information on a conversation partner when writing or receiving a message. In this case, the processor 122 executes at least one program stored in the memory 110 and controls the program so that a function corresponding to the program is performed. For example, the processor 122 may include a display processor that collects and displays activity information on a designated conversation partner when the conversation partner is designated by a user. That is, the message writing function of the electronic device 100 may be formed by using software such as programs stored in the memory 110 or hardware such as the display processor.

The audio processing unit 130 provides an audio interface between a user and the electronic device 100 through a speaker 131 and a microphone 132.

The communication system 140 performs a communication function for voice and data communications of the electronic device 100. In this case, the communication system may be divided into a plurality of communication sub modules that support different communication networks. For example, the communication networks may include a Global System for Mobile Communication (GSM) network, an Enhanced Data GSM Environment (EDGE) network, a Code Division Multiple Access (CDMA) network, a W-Code Division Multiple Access (W-CDMA) network, an Long Term Evolution (LIE) network, an Orthogonal Frequency Division Multiple Access (OFDMA) network, a wireless LAN, a Bluetooth network, and a Near Field Communication (NFC) network, but is not limited thereto. According to the present disclosure, the communication system 140 may transmit and receive activity information and messages to and from a conversation partner.

The input and output control unit 150 connects input and output devices such as the touch screen 160 and the input unit 170 via the interface.

The touch screen 160 is an input and output device through which information is input and output, and may include a touch input unit 161 and a display unit 162.

The touch input unit 161 provides touch information detected through a touch panel to the processor unit 120 through the input and output control unit 150. In this case, the touch input unit 161 changes the touch information to a command structure such as touchdown, touch_move, and touch_up and provides the command structure to the processor unit 120 to be able to generate a user input that designates a conversation partner to which a message is transmitted according to the present disclosure, and a touch input that selects activity information to be shared with the conversation partner among pieces of activity information.

The display unit 162 displays state information on the electronic device 100, and texts, moving pictures, and still pictures that are input by a user. For example, the display unit 162 may display the content of a conversation with a conversation partner, and activity information related to the conversation partner.

The input unit 170 provides input data generated by the selection of a user to the processor unit 120 through the input and output control unit 150. For example, the input unit 170 may include a control button for controlling the electronic device 100. As another example, the input unit 170 may include a keypad for receiving input data from a user and generate a user input that designates a conversation partner to which a message is transmitted according to the present disclosure, and an input that selects activity information to be shared with the conversation partner among pieces of activity information.

Although not shown, the electronic device 100 may further include components for additional functions, such as a camera module for capturing images or moving pictures, a broadcast reception module for receiving broadcasts, a digital sound source playing module such as an MP3 module, a near field communication module for near field communication, a proximity sensor module for proximity sensing, and software for operating these components.

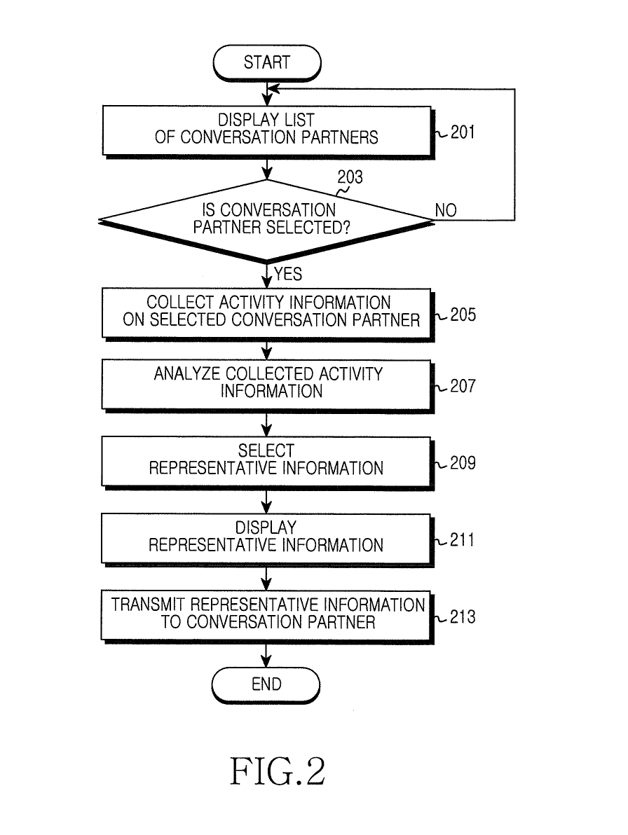

FIG. 2 is a flow chart of a message writing process by an electronic device according to an embodiment of the present disclosure.

Referring to FIG. 2, the electronic device displays a list of conversation partners in operation 201 and then selects a conversation partner (counterpart) to which a written message is transmitted, in operation 203. Here, writing a message means writing content to be transmitted to the conversation partner, the message means a message that is transmitted through an instant messenger, a text message, or an email, and the list of conversation partners may be a list of conversation partners for an instant messenger, phone book data for a message function, or address list information for an email function.

If the conversation partner to which the written message is transmitted is not selected in operation 203, the electronic device repeats operation 201.

Alternatively, if the conversation partner to which the written message is transmitted is selected in operation 203, the electronic device proceeds to operation 205 and collects activity information on the selected conversation partner. Here, the activity information is the activity records of the conversation partner recorded on a network and may be pictures, writings, or personal events that are registered by a user. As an example, the activity information may be pictures, writings (for example, a restaurant review, a product review, a travel review, and personal feelings), a user birthday, and family-member birthdays that are registered with a social network by the conversation partner selected by a user of the electronic device. In addition, the activity information includes communication records generated between the user of the electronic device and the conversation partner, and may be the content of a message and data that are transmitted and received through an email, a text message, and a messenger among users.

One of reasons why such activity information is collected is to recognize the recent situation of the selected conversation partner and another reason is to alleviate awkwardness between the user and the selected conversation partner.

Since writing may occur between users without facing each other when a conversation is made by using a message, starting a conversation with a conversation partner who is not close may be awkward. Thus, according to the present disclosure, the electronic device may provide activity information on a conversation partner and a user of the electronic device may transmit and receive a short greeting to and from a selected conversation partner by using the activity information. That is, the user of the electronic device may recognize the activity information on the conversation partner and transmit an opinion on the activity information to the conversation partner. Such activity information is related to the conversation partner and thus users may naturally have a conversation by using the activity information as a common topic.

Such activity information on the conversation partner may be collected in the following way.

Firstly, the electronic device may collect activity information from a server that provides a service that is used by a selected conversation partner. For example, the electronic device may access a first server (a social service server that provides an A service), collect records on the conversation partner therefrom, access a second server, and collect records on the conversation partner therefrom. In this way, the electronic device accesses a plurality of external servers from which activity information may be collected, and collects records on the conversation partner.

In addition, the electronic device may collect conversation records with the conversation partner stored in a memory, such as messages and data that are previously exchanged with the conversation partner.

Subsequently, the electronic device proceeds to operation 207 to analyze the collected activity information and then proceeds to operation 209 to select representative information. Here, the electronic device extracts, among the collected activity information, activity information that may be used for a greeting with the conversation partner, and defines, as representative information, the activity information that may be used for the greeting.

As an example, the electronic device may define representative information among the collected activity information by using time information. That is, the electronic device may define, as representative information, activity information since a specific timing among the collected activity information or define the most recent activity information as representative information.

As another example, the electronic device may define representative information among the collected activity information by using a specific keyword (for example, types of activity information (images, moving pictures, writing, etc.), activity information based on regions, etc.).

Moreover, the electronic device may select one or more pieces of representative information among the collected activity information.

The electronic device that selects representative information in the above-described way may proceed to operation 211 to display the selected representative information. Here, the representative information may be displayed on a part of a display area or as the background of the display area. When the representative information is displayed on the part of the display area, the electronic device may display the representative information on a part that does not overlap with a message input area so that it is possible to write a message while seeing the representative information.

The electronic device that displays the selected representative information in the above-described way may proceed to operation 213 to transmit the representative information to the conversation partner. This is to enable a user to share the representative information with the conversation partner so that awkwardness between them is alleviated through an exchange using the representative information.

In summary, the electronic device provides activity information on the conversation partner to the user so that the user may learn the recent situation of the conversation partner before transmitting a first message and users may talk on the activity information to have a natural conversation without awkwardness. That is to say, the electronic device provides an icebreaking function.

As an example, if the electronic device collects activity information on a movie review and determines that the conversation partner watched a movie, a user of the electronic device may start a conversation, offering a movie criticism to the conversation partner.

The electronic device that transmits represent information to the conversation partner in the above-described way then terminates this process.

The electronic device collects activity information on a conversation partner in a one to one conversation but may also collect activity information on conversation partners in a situation where a group conversation is performed. In this case, the electronic device may collect activity information corresponding to each conversation partner in the group, but as the group conversation is performed among close users, one piece of activity information that all conversation partners share among pieces of activity information on all the conversation partners may be defined as representative information. As an example, activity information on each conversation partner is collected and then the most recent activity information without distinction of conversation partners is defined as representative information.

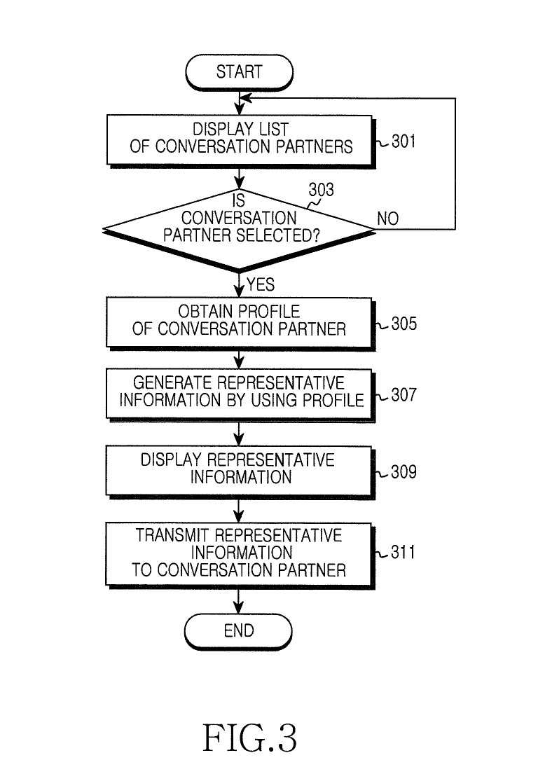

FIG. 3 is a flow chart of a message writing process by an electronic device according to another embodiment of the present disclosure.

Referring to FIG. 3, the electronic device displays a list of conversation partners in operation 301 and then proceeds to operation 303 to select a conversation partner to which a written message is transmitted. Here, writing a message means writing content to be transmitted to the conversation partner selected by a user the electronic device, the message means a message that is transmitted through an instant messenger, a text message, or an email, and the list of conversation partners may be a list of conversation partners for an instant messenger, phone book data for a message function, or address list information for an email function.

If the conversation partner to which the written message is transmitted is not selected in operation 303, the electronic device repeats operation 301.

Alternatively, if the conversation partner to which the written message is transmitted is selected in operation 303, the electronic device proceeds to operation 305 to collect a profile of the selected conversation partner and then proceeds to operation 307 to generate representative information by using the obtained profile. Here, the profile of the conversation profile indicates information that is input directly by the selected conversation partner to open to the public, such as user name, birthday, telephone number, and pictures, and the electronic device may generate representative information by using the open profile information as described above.

In this case, the electronic device generates information able to be shared with the conversation partner by using the profile information on the conversation partner.

As an example, the electronic device may generate horoscope information on the conversation partner by using a birthday and name among the profile information on the conversation partner and define the horoscope information as representative information.

As another example, the electronic device may generate bio rhythm information by using a birthday and name among the profile information on the conversation partner and define the bio rhythm information as representative information.

As another example, the electronic device may write a birthday card by using a birthday among the profile information on the conversation partner and define corresponding information as representative information.

As another example, the electronic device may determine an entertainer resembling the conversation partner by using pictures among the profile information on the conversation partner and define corresponding information as representative information.

The representative information is information that may become a common topic between a user of the electronic device and the conversation partner as described above, and may include information on the background place of a profile picture, and attraction information on where the conversation partner resides.

Moreover, the electronic device may generate representative information by using an internal program or provide profile information to an external server and receive representative information from the external server.

The electronic device that generates activity information as described above may proceed to operation 309 to display the generated representative information and then proceed to operation 311 to transmit the representative information to the conversation partner.

Subsequently, the electronic device terminates this process.

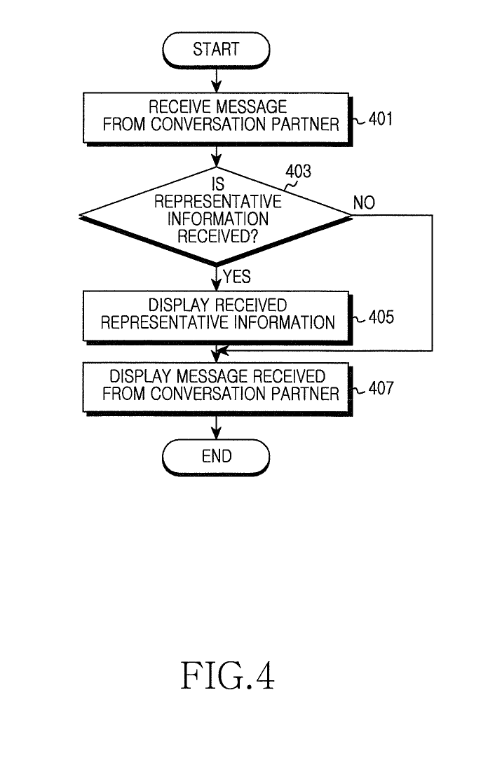

FIG. 4 is a flow chart of a message receiving process by an electronic device according to an embodiment of the present disclosure.

Referring to FIG. 4, the electronic device receives a message from the conversation partner in operation 401 and then proceeds to operation 403 to check whether representative information is also received.

Here, the representative information indicates activity information on a user of the electronic device that is collected by the conversation partner. That is, the user of the electronic device may register pictures with a network and such information may be collected by a conversation partner that requests a conversation.

If it is recognized in operation 403 that representative information is received, the electronic device may proceed to operation 405 to display the received representative information and then proceed to operation 407 to display the content of the message received from the conversation partner.

In some embodiments, the electronic device may display the received representative information on a part of a display area or set it as the background of the display area to have a conversation with a conversation partner by using the representative information as a common topic.

Alternatively, if the representative information is not received in operation 403, the electronic device may proceed to operation 407 to display the content of the received message.

In summary, if the electronic device receives representative information along with a message, it displays the representative information along with the content of the message so that a user of the electronic device may have a conversation, offering a natural greeting to a conversation partner.

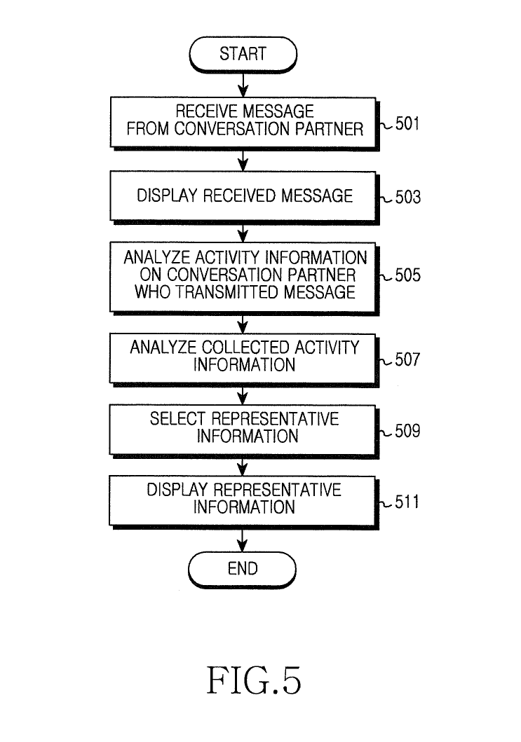

FIG. 5 is a flow chart of a message receiving process by an electronic device according to another embodiment of the present disclosure.

Referring to FIG. 5, the electronic device receives a message from a conversation partner that requests a conversation, in operation 501, and then proceeds to operation 503 to display the content of the received message. Here, the message may be a message that is received through an instant messenger, a short message, or an email. If the electronic device receives, for example, an instant message or a short message from the conversation partner, it may display the content of the received message on a conversation screen that displays the content of transmitted and received messages.

Subsequently, the electronic device may proceed to operation 505 to collect activity information on the conversation partner that has transmitted the message. This is to prevent an awkward conversation when the user of the electronic device is not close to the conversation partner or there has been no frequent contact. That is, the user of the electronic device may learn a recent situation of the conversation partner based on the collected activity information and offer a greeting by using the learned recent situation. Moreover, the user of the electronic device has a short conversation with the conversation partner based on the activity information on the conversation partner and then has a major conversation.

Subsequently, the electronic device may proceed to operation 507 to analyze the collected activity information and then proceed to operation 509 to select representative information. Here, the electronic device extracts, among the collected activity information, activity information that may be used for a greeting with the conversation partner, and defines, as representative information, the activity information that may be used for the greeting.

As an example, the electronic device may define representative information among the collected activity information by using time information. That is, the electronic device may define, as representative information, activity information since a specific timing among the collected activity information, or define the most recent activity information as representative information.

As another example, the electronic device may define representative information among the collected activity information by using a specific keyword.

Moreover, the electronic device may select one or more pieces of representative information among the collected activity information.

The electronic device that selects representative information as described above may proceed to operation 511 to display the selected representative information.

Here, the representative information may be displayed on a part of a display area or as the background of the display area.

When the representative information is displayed on the part of the display area, the electronic device may display the representative information on a part that does not overlap with a message input area so that it is possible to write a message while seeing the representative information.

The electronic device that displays representative information as described above terminates this algorithm. Here, terminating the algorithm does not mean terminating a message writing function but means terminating the function of collecting activity information on a conversation partner, and the electronic device would continue providing a conversation function using a test message.

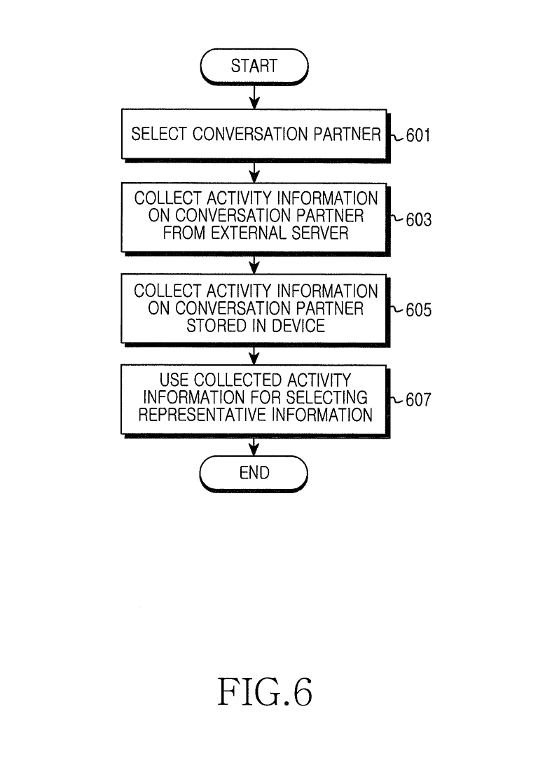

FIG. 6 is a flow chart of a process of collecting activity information by an electronic device according to an embodiment of the present disclosure.

Referring to FIG. 6, the electronic device may learn activity information on a conversation partner before having a conversation with the conversation partner and thus recognize his/her recent situation as described above. Here, the activity information on the conversation partner may include records on the activities of the conversation partner conducted on a network and may include pictures, writings, and personal events that are registered by the conversation partner.

For example, the activity information may include pictures, writings (for example, a restaurant review, a product review, a travel review, and personal feelings), a user birthday, and family-member birthdays that are registered with a social network by a conversation partner designated by a user of the electronic device.

In addition, the activity information may include communication records generated between the user of the electronic device and the user's conversation partner and may include data and messages that are exchanged between users.

In some embodiments, examples of the activity information may include the records in an email, a text message, or a messenger which the user of the electronic device and the user's conversation partner have exchanged in the past.

The electronic device for collecting such activity information selects a conversation partner in operation 601. Here, the electronic device may display a list of conversation partners and then recognize a conversation partner selected by a user of the electronic device.

Subsequently, the electronic device proceeds to operation 603 to collect activity information on the conversation partner from an external server. The electronic device may collect activity information on the conversation partner from each of servers providing social services. As an example, if the user of the electronic device designates “Andrew” as a conversation partner, the electronic device may access an accessible server and collect information registered by the conversation partner “Andrew”. Here, the information registered by the conversation partner “Andrew” means activity information.

In some embodiments, the electronic device may use a function (Open API) opened by a business providing a social service to collect the activity information on the conversation partner.

The electronic device that collects the activity information on the conversation partner from an external server as described above may proceed to operation 605 to collect the activity information on the conversation partner that is stored in the electronic device. Here, the activity information stored in the electronic device indicates records on messages and data that the user of the electronic device has exchanged with the selected conversation partner. As an example, the activity information may include records on previous conversations with the conversation partner that the user of the electronic device has transmitted and received by using an instant messenger.

In addition, the electronic device may periodically receive activity information from an external server, store the received activity information in an inner memory and then collect activity information from the inner memory when the activity information is to be used.

Subsequently, the electronic device proceeds to operation 607 to use the activity information collected from the external server and the electronic device for selecting representative information and then terminates this process.

Although FIG. 6 describes an example of collecting the activity information from both the external server and the electronic device, the electronic device according to the present disclosure may collect the activity information from the external server. Alternatively, the electronic device may collect the activity information from its inner memory and use the collected activity information for setting representative information. In addition to the above-described ways, the electronic device according to the present disclosure may receive activity information on the conversation partner from another user who is close to the conversation partner.

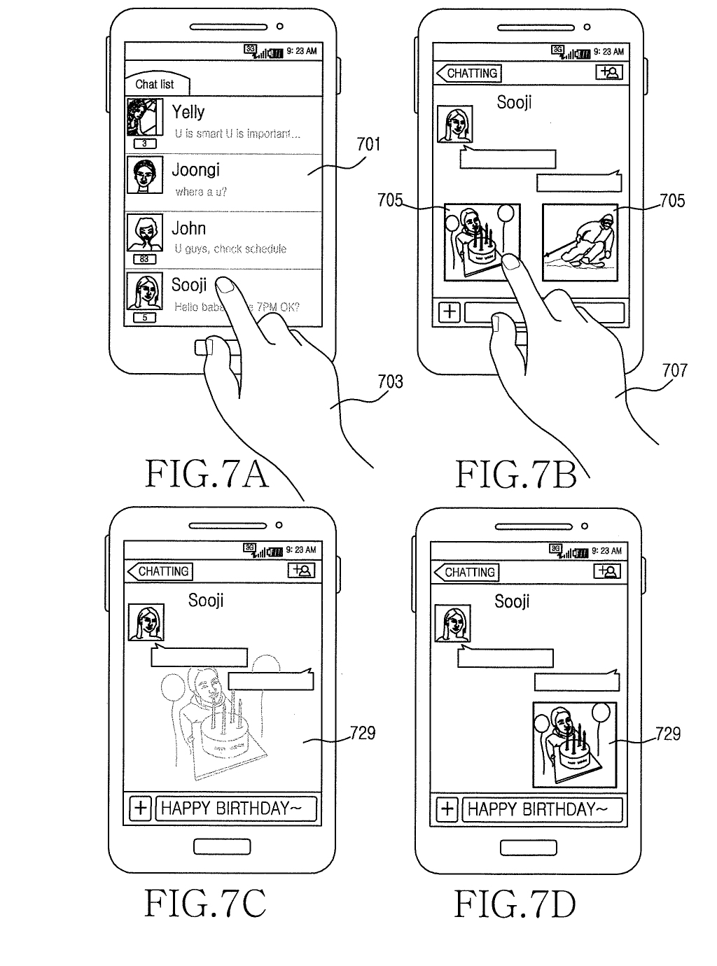

FIGS. 7A to 7D show message writing screens of an electronic device according to an embodiment of the present disclosure.

Referring to FIGS. 7A to 7D, the electronic device may write a message to be transmitted to a conversation partner by using an instant messenger service, a text message service, or an email service. In the case of the instant messenger service for example, the electronic device may display a pre-registered list 701 of conversation partners to provide the conversation partners as shown in FIG. 7A.

FIG. 7A shows a screen of the electronic device on which a list of conversation partners having Yelly, Joongi, John, and Sooji as registered users is displayed. As indicated by reference numeral 703, the user of the electronic device designates Sooji as a conversation partner.

The electronic device recognizing that the conversation partner is designated by the user as described above would collect activity information on the user Sooji. If the activity information on the conversation partner is collected, the electronic device may display a conversation screen on which a conversation with the designated conversation partner may be conducted, and display the activity information related to the conversation partner on a part of a conversation area.

That is, if the designated conversation partner registers (uploads) a birthday party picture and a skiing picture by using a social service, the electronic device will collect pictures registered by the conversation partner and define the collected pictures as activity information. Thus, as shown in FIG. 7B, the electronic device may display a conversation screen including previously exchanged message content and a message input area and simultaneously display, on a part of the conversation screen, the birthday party picture and the skiing picture that are the activity information 705 collected on the conversation partner Sooji

In addition, such activity information may be transmitted to the conversation partner so that the user of the electronic device and the conversation partner may share the activity information. That is, while two pieces of activity information (the birthday party picture and the skiing picture) 705 are displayed as shown in FIG. 7B, the user of the electronic device may select 707 at least one piece of activity information to be transmitted to the conversation partner. The selected activity information may be expanded at a predetermined magnification or set as the background of the conversation screen as shown in FIG. 7C so that transmitted or received messages are displayed on the activity information.

The electronic device recognizing that activity information is selected as described above may transmit 709 the selected activity information to the conversation partner Sooji as shown in FIG. 7D. FIG. 7D shows a screen on which the user of the electronic device inputs the greeting “Happy birthday˜” to match the activity information on the conversation partner and attempts to have a conversation.

The conversation partner that receives the activity information may display the received activity information on a part of the conversation screen or set as the background of the conversation screen.

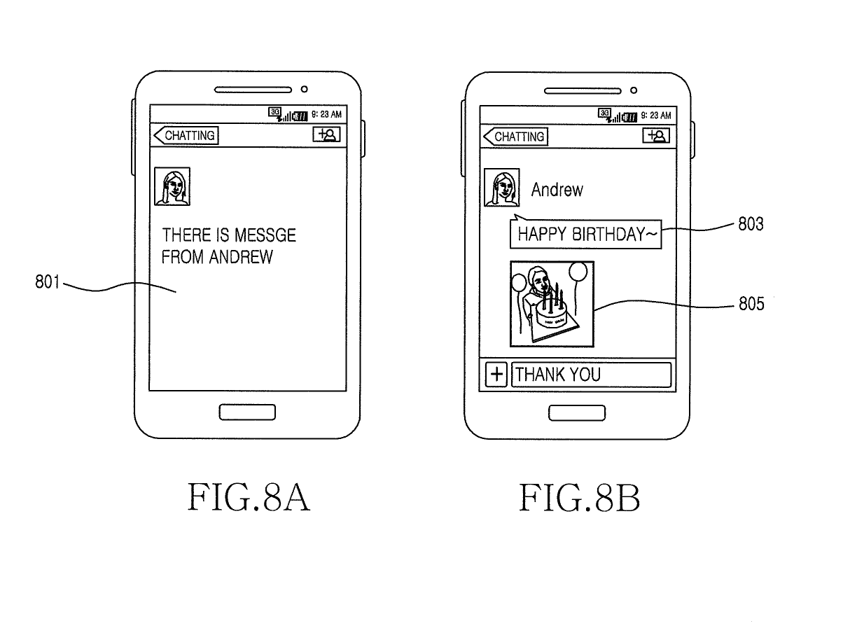

FIGS. 8A and 8B show message receiving screens of an electronic device according to an embodiment of the present disclosure.

Referring to FIGS. 8A and 8B, the electronic device may use an instant messenger service, a text message service, or an email service to receive a message from a conversation partner. In the case of the instant messenger service for example, if the electronic device receives a message from a conversation partner, it displays information 801 notifying the reception of the message as shown in FIG. 8A.

FIG. 8A shows a screen on which information notifying that a message is received from the conversation partner Andrew is displayed. A user of the electronic device may display a conversation screen for the conversation partner Andrew to see the content of the received message. In general, the electronic device may detect an input of the user who executes the instant messenger or detect an input of the user from the displayed information and perform processing so that the conversation screen is displayed.

FIG. 8B shows a screen of the electronic device on which the content of the message received from the conversation partner Andrew is displayed. The electronic device receives, from the conversation partner Andrew, activity information 805 collected by the conversation partner Andrew along with the message “Happy birthday˜” 803. In addition, the user of the electronic device may transmit a response to the birthday greeting and start a conversation on the received activity information with the conversation partner Andrew.

From FIGS. 8A and 8B, it may be seen that the conversation partner Andrew has collected activity information on the user of the electronic device and has transmitted a birthday greeting by using the collected activity information.

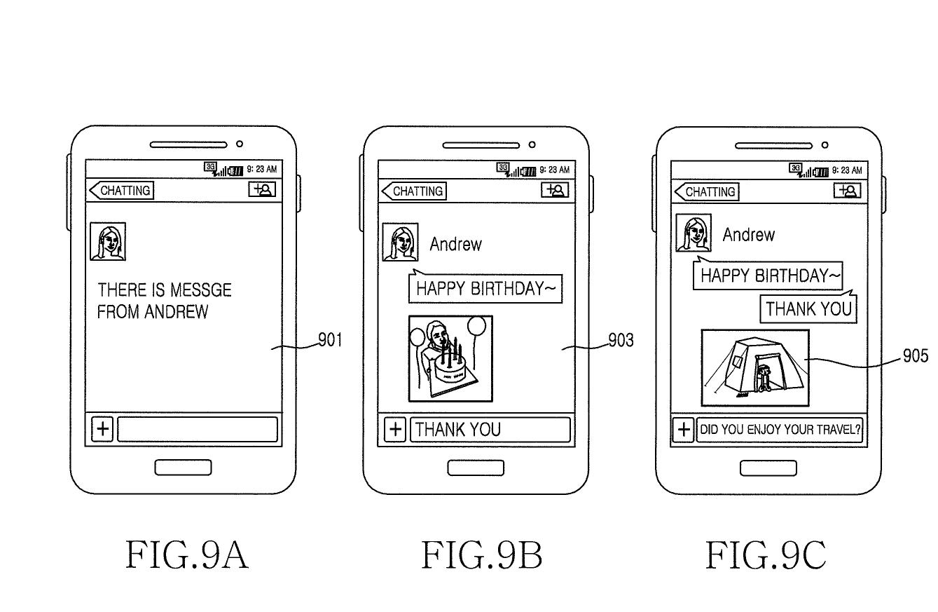

FIGS. 9A to 9C show message receiving screens of an electronic device according to another embodiment of the present disclosure.

Referring to FIGS. 9A to 9C, the electronic device may use an instant messenger service, a text message service, or an email service to receive a message from a conversation partner. In the case of the instant messenger service for example, if the electronic device receives a message from a conversation partner, it displays 901 information notifying the reception of the message as shown in FIG. 9A.

FIG. 9A shows a screen on which information notifying that a message is received from the conversation partner Andrew is displayed. A user of the electronic device may display a conversation screen for the conversation partner Andrew to see the content of the received message. In general, the electronic device may detect an input of the user who executes the instant messenger or detect an input of the user from the displayed information and perform processing so that the conversation screen is displayed.

FIG. 9B shows a screen of the electronic device on which the content of the message received from the conversation partner Andrew is displayed. The electronic device receives, from the conversation partner Andrew, activity information 805 collected by the conversation partner Andrew along with the message “Happy birthday˜” and displays 903 the received activity information. In addition, the user of the electronic device may transmit a response to the birthday greeting and start a conversation on the received activity information with the conversation partner Andrew.

From FIGS. 9A and 9B, it may be seen that the conversation partner Andrew has collected activity information on the user of the electronic device and has transmitted a birthday greeting by using the collected activity information.

The electronic device that receives activity information from the conversation partner as described above may collect activity information on the conversation partner who transmits a message. This is to enable the user of the electronic device to learn a recent situation of the conversation partner Andrew, the user not knowing the recent situation of Andrew because there has been no frequent contact. For example, even after the conversation partner Andrew starts a conversation, the electronic device collects activity information on the conversation partner Andrew as shown in FIG. 9C.

FIG. 9C shows that the electronic device has obtained a travel picture as activity information on the conversation partner Andrew and has transmitted 905 the obtained picture to the conversation partner Andrew. Thus, the user of the electronic device may transmit a greeting message on a travel to the conversation partner Andrew.

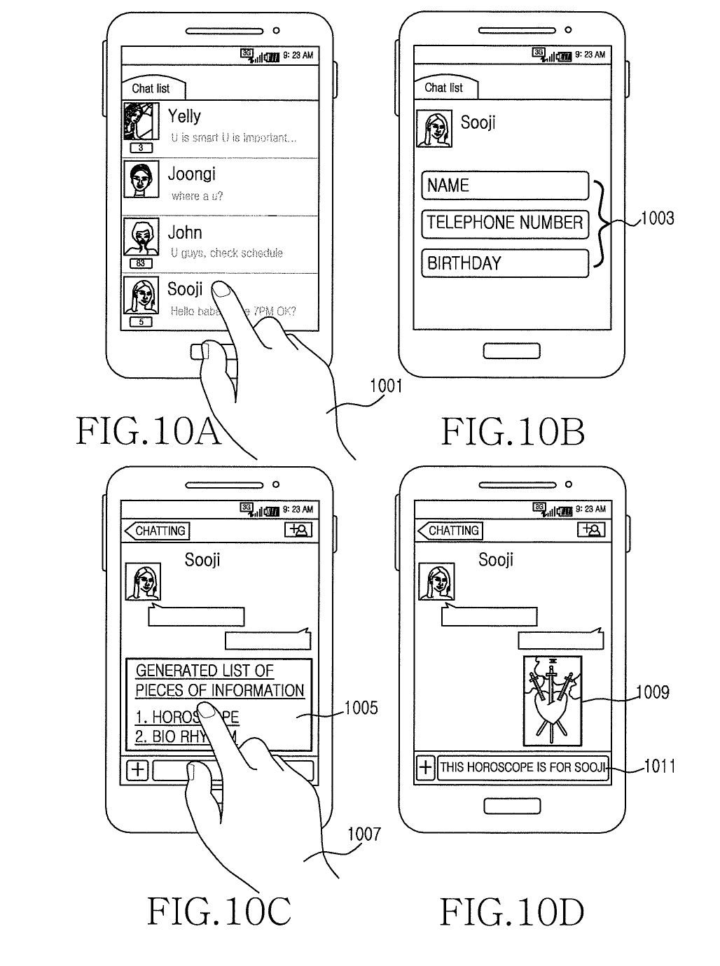

FIGS. 10A to 10D show message writing screens of an electronic device according to another embodiment of the present disclosure.

Referring to FIGS. 10A to 10D, the electronic device may write a message to be transmitted to a conversation partner by using an instant messenger service, a text message service, or an email service. In the case of the instant messenger service for example, the electronic device displays 701 may display a pre-registered list of conversation partners to provide the conversation partners as shown in FIG. 10A.

FIG. 10A shows a screen of the electronic device on which a list of conversation partners having Yelly, Joongi, John, Sooji as registered users is displayed. The user of the electronic device designates Sooji as a conversation partner, as indicated at 1001.

The electronic device recognizing that the conversation partner has been designated as described above may see a profile (for example, name, telephone number, birthday, etc.) 1003 of the conversation partner Sooji and generate representative information by using the profile as described in FIG. 10B. Here, the representative information includes information that may be shared with the conversation partner, and may generate horoscope information, bio rhythm information, etc. by using a profile of the conversation partner.

The electronic device that has generated such representation information displays a generated list of pieces of representative information on a conversation screen as shown in FIG. 10C. That is, FIG. 10C shows a screen on which a list of horoscope information and bio rhythm information that are generated by the electronic device is displayed 1005.

The electronic device selects, from the displayed list, representative information to be transmitted to the conversation partner and if a user selects 1007 horoscope information as shown, the electronic device may perform processing to transmit, to the conversation partner, user message 1011 on the horoscope information along with representative information (horoscope information) 1009 as shown in FIG. 10D.

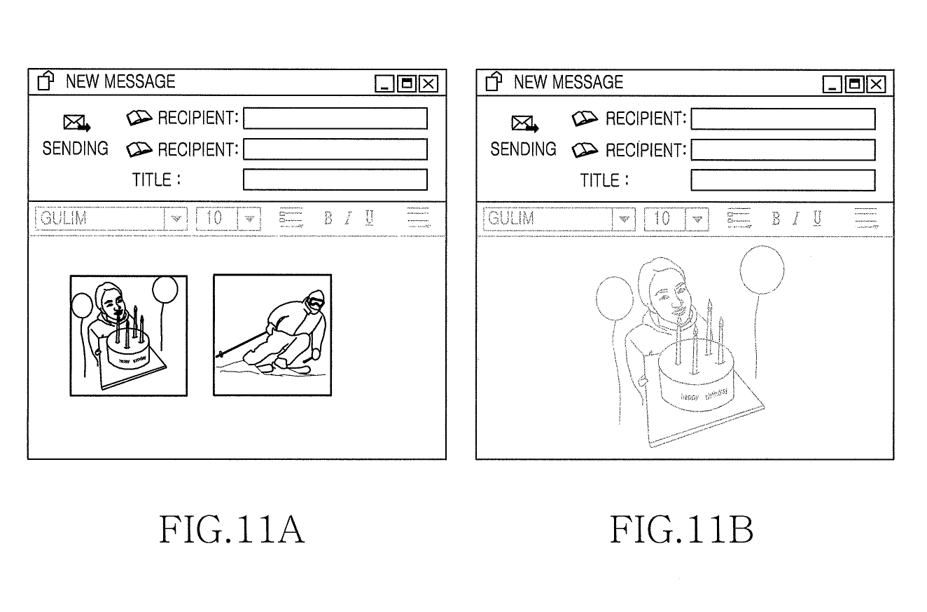

FIGS. 11A and 11B show message writing screens of an electronic device according to another embodiment of the present disclosure.

Referring to FIGS. 11A and 11B, the electronic device may provide activity information on an email function. That is, if a recipient of an email is selected, the electronic device may use information (for example, an email address, and a user name) of the selected user to collect activity information on the recipient.

In this case, the electronic device may retrieve an external server or a memory in the electronic device as previously described to collect activity information. Since a social service recently uses an email address as ID in many cases, it is possible to collect activity information by using the recipient's email address.

The electronic device that has collected activity information on the recipient as described above may insert the collected activity information into an email writing screen and enable a user to write a message on the inserted activity information, as shown in FIG. 11A. In some embodiments, the electronic device may set the collected activity information as the background of the email writing screen and enable a user to write a message by using the activity information as the background as shown in FIG. 11B.

When the electronic device according to the present disclosure writes a message on the counterpart user by using an instant messenger function or an email function or receives a message from the counterpart user, it is possible to learn the recent situation of the counterpart user as previously described. Such services may be applied to a function in which a counterpart user may be designated, such as a text message function, a multimedia message function, and a data transmission function in addition to the above-mentioned functions.

According to an electronic device and method for writing a message, before writing a message or when receiving the message, it is possible to learn a recent situation of a counterpart user and lead to a natural conversation by using the recent situation. In addition, it is possible to increase closeness to a conversation partner by sharing the recent situation grasped by the electronic device.

Methods according to embodiments described in the following claims and/or the specification of the present disclosure may be implemented in hardware, in software, or as a combination thereof.

When the methods are implemented in software, a computer readable recording medium that stores one or more programs (software modules) may be provided. One or more programs stored in the computer readable recording medium are configured to be executed by one or more processors in the electronic device. One or more programs include instructions that allow the electronic device to execute the methods according to the embodiments described in the claims and/or the specification of the present disclosure.

Such programs (software modules or software) may be stored in random access memories (RAMs), non-volatile memories including flash memories, read only memories (ROMs), Electrically Erasable Programmable Read Only Memories (EEPROMs), magnetic disc storage devices, Compact Disc-ROMs (CD-ROMs), Digital Versatile Discs (DVDs), other types of optical storage devices, or magnetic cassettes. Alternatively, the programs may be stored in a memory that includes a combination of some or all thereof. Moreover, each component memory may be included in plural.

Moreover, the programs may be stored in an attachable storage device that is accessible to the electronic device through a communication network such as the Internet, Intranet, a local area network (LAN), a wide LAN (WLAN), or a storage area network (SAN), or through a communication network including a combination thereof. Such a storage device may access the electronic device through an external port.

Moreover, a separate storage device on a communication network may also access a portable electronic device.

While particular embodiments have been described in the detailed description of the present disclosure, several variations may be made without departing from the scope of the present disclosure. Therefore, the scope of the present disclosure should not be limited to the above-described embodiments but be defined by the following claims and equivalents thereof.

What is claimed is:

1. A method in an electronic device, the method comprising:
collecting conversation information through which a recent situation of a conversation partner is recognized; and
transmitting a greeting message to the conversation partner, wherein the greeting message is written before writing a message by using the collected conversation information.

2. The method of claim 1, further comprising sharing the collected conversation information with the conversation partner.

3. The method of claim 1, wherein the collecting of the conversation information is performed when a conversation partner receiving a written message is designated or when a message is received from a conversation partner.

4. The method of claim 1, wherein the collecting of the conversation information comprises one of collecting information registered with a network by the conversation partner and collecting communication records between a user of the electronic device and the conversation partner.

5. The method of claim 1, wherein the collecting of the conversation information comprises generating conversation information by using a profile of a conversation partner selected to generate a message.

6. The method of claim 1, wherein the collected conversation information is displayed on a message writing screen or set as the background of the message writing screen.

7. The method of claim 1, wherein the message comprises one of a text message, an instant message, an email, and a multimedia message.

8. The method of claim 1, wherein the collecting of the conversation information comprises collecting at least one of: pictures, writings, and personal events that are registered with a network by a conversation partner; content of messages that have been transmitted to and received from a conversation partner; and data transmitted to and received from a conversation partner.

9. A device for writing a message by means of an electronic device, the device comprising:
at least one processor; and
a memory;
wherein the at least one processor is configured to collect conversation information through which a recent situation of a conversation partner is recognized, and to write and transmit a greeting message to the conversation partner, wherein the greeting message is written before writing a message by using the collected conversation information.

10. The device of claim 9, wherein the at least one processor is further configured to share the collected conversation information with the conversation partner.

11. The device of claim 9, wherein the at least one processor is further configured to collect the conversation information, when a conversation partner receiving a written message is designated or when a message is received from a conversation partner.

12. The device of claim 12, wherein the at least one processor is further configured to collect the conversation information, with information registered with a network by the conversation partner and communication records between a user of the electronic user and the conversation partner.

13. The device of claim 9, wherein the at least one processor is further configured to generate the conversation information by using a profile of a conversation partner selected to receive a message.

14. The device of claim 9, wherein the at least one processor is further configured to display the conversation information on a message writing screen or to set the conversation information as the background of the message writing screen.

15. The device of claim 9, wherein the at least one processor is further configured to collect the conversation information, when a message is written by using one of a text message, an instant message, an email, and a multimedia message.

16. The device of claim 9, wherein the at least one processor is further configured to collect, as the conversation information, at least one of: pictures, writings, and personal events that are registered with a network by a conversation partner; content of messages that have been transmitted to and received from a conversation partner; and data transmitted to and received from a conversation partner.

17. A non-transitory computer readable recording medium encoded with at least one program that includes instructions that when executed by an electronic device, cause the electronic device to perform:
collecting conversation information through which a recent situation of a conversation partner is recognized; and
transmitting a greeting message to the conversation partner, wherein the greeting message is written before writing a message by using the collected conversation information.

18. The non-transitory computer readable recording medium of claim 17, wherein the instructions further cause the electronic device to perform:
sharing the collected conversation information with the conversation partner.

19. The non-transitory computer readable recording medium of claim 17, wherein the collecting of the conversation information is performed when a conversation partner receiving a written message is designated or when a message is received from a conversation partner.

20. The non-transitory computer readable recording medium of claim 17, wherein the collecting of the conversation information comprises one of collecting information registered with a network by the conversation partner and collecting communication records between a user of the electronic device and the conversation partner.
